(19) United States
(12) Patent Application Publication
(10) Pub. No.: US 2008/0202088 A1
(43) Pub. Date: Aug. 28, 2008

(54) Apparatus and method for handling a cutting device

(76) Inventor: Clinton J. Angelle, Breaux Bridge, LA (US)

Correspondence Address: LONGMAN RUSSO;A PROFESSIONAL LAW CORPORATION, P.O. DRAWER 3408, LAFAYETTE, LA, 70502-3408, US

(21) Appl. No.: 11/710,887

(22) Filed: Feb. 26, 2007

(51) Int. Cl. B26B 7/00; A01D 34/00

(52) U.S. Cl. 56/12.7; 30/276

(57) ABSTRACT

An apparatus for holding a vegetation cutting device. The cutting device includes a cutting head, a handle attached to the cutting head, and a power unit attached to the handle and supplying power to the cutting head. The apparatus comprises a clamp member having disposed therein the device handle, and wherein the clamp member including a cylinder member. The apparatus further comprises a pole support operatively associated with the cylinder member, a knob and stem for selectively attaching the clamp member to the pole support, and an angle adjustment plate operatively attached to the pole support. The apparatus further comprises a caster, operatively attached to the pole support, for rotatably moving the cutting head, apertures for orienting the angle adjustment plate to a proper orientation with respect to the wheel member, and a tab operatively attached to the pole support for rotating the pole support to align with the apertures.

### BACKGROUND OF THE INVENTION

This invention relates to a device used in the cutting of vegetation. More specifically, but not by way of limitation, this inventions relates to an apparatus for handling a vegetation cutting device.

Many types of prior art vegetation cutting devices have been developed. Vegetation cutting devices are referred to as weed and grass trimmers. Weed and grass trimmers are commercially available from Stihl Incorporated under the name FS 80 Trimmer. Generally, the trimmers have a cutting head section connected to a handle, which in turn is connected to a power section. The cutting head is generally a circular center segment having at least one cutting arm, and wherein the cutting arm may be a flexible polymeric member having properties similar to fishing line.

Regardless of the exact type of trimmer used, operators have a difficult problem handling the cutting heads. While the prior art trimmers are useful and convenient, the design is ergonomically unfriendly. Prior art designs make it difficult to maneuver the cutting head in the various positions required when cutting grass, shrubbery, vegetation, sidewalks, etc. Prior art designs make it particularly difficult to maneuver the cutting head after prolonged use.

Therefore, there is a need for an apparatus for handling a vegetation cutting device. There is also a need for a vegetation cutting device. Further, there is a need for an apparatus that will allow for easy maneuvering and steering during operation. Additionally, there is a need for a method of cutting vegetation that allows for an operator to easily change the orientation of the cutting head to suit the operator's specific circumstances. There is also a need for a vegetation cutting device that is ergonomically engineered to allow ease of use and control by the operator. These needs, as well as many others, will be met by the following disclosure.

### SUMMARY OF THE INVENTION

An apparatus for handling a vegetation cutting device is disclosed. The cutting device includes a cutting head, a handle attached to the cutting head, and a power unit attached to the handle and supplying power to the cutting head. The apparatus comprises a clamp member having disposed therein the device handle, and wherein the clamp member includes a cylinder member. The apparatus further comprises a pole support operatively associated with the cylinder member, means for selectively attaching the clamp member to the pole support, and an angle adjustment plate operatively attached to the pole support. The apparatus further comprises a caster means, operatively attached to the pole support, for rotatably moving the cutting head, means for orienting the angle adjustment plate to a proper orientation with respect to the wheel member, and a tab member operatively attached to the pole support for rotating the pole support to align with the orienting means.

In one preferred embodiment, the caster means comprises a bracket extending from the angle adjustment plate and a wheel operatively attached to the bracket. Also, in the most preferred embodiment, the wheel includes a first elliptical surface extending to a cylindrical surface, which in turn extends to a second elliptical surface. Additionally, in the preferred embodiment, the cylindrical surface has a width providing a contact surface so that as the cylindrical surface contacts the ground surface, the rolling friction resistance is significantly reduced.

The clamp member, in one preferred embodiment, includes an indented portion configured to clasp the handle of the cutting device. The indented portion may be at an angle between 20 degrees and 50 degrees relative to the pole support. In the preferred embodiment, the orienting means includes a series of apertures in the angle adjustment plate. Additionally, the clamp means may include dial means for rotating the handle so that the angle of the handle is adjustable, and wherein the angle of the handle is adjustable relative to the pole support. In the preferred embodiment, the dial means includes a first plate having serrated teeth disposed about a center and a second plate having reciprocal serrated teeth disposed about a center, and wherein the first plate and the second plate are configured to engage.

In one preferred embodiment, the attaching means includes a knob with a stem and wherein the stem is configured to engage the pole support in order to slidably adjust the clamp member relative to the pole support. Additionally, the apparatus may further comprise a locking means for locking the tab member in place relative to the angle adjustment plate. The locking means may comprise a pin configured to engage the apertures in the angle adjustment plate.

A method for cutting vegetation is also disclosed. The method comprises providing a cutting device, with the device comprising a cutting head, a handle attached to the cutting head, a power unit attached to the handle and supplying power to the cutting head, a clamp member having disposed therein the device handle, with the clamp including a cylinder member, a pole operatively associated with the cylinder member; and means for selectively attaching the clamp to the pole. The device further comprises an angle adjustment plate operatively attached to the pole, with the angle adjustment plate having a bracket extending therefrom, a wheel operatively attached to the bracket, a series of apertures for orienting the angle adjustment plate to a proper orientation, and a tab operatively attached to the pole for rotating the pole in order to select the aperture.

The method further comprises adjusting the height of the clamp relative to the pole so that the height of the cutting head is changed and energizing the power unit. The method further includes rotating the cutting head and cutting the vegetation with the cutting head. In the preferred embodiment, the method further includes terminating the power to the power unit, and adjusting the orientation of the wheel, wherein the orientation of the wheel is adjusted by engaging the tab with a selected aperture so that the direction of the wheel is adjusted.

In another preferred embodiment, a device for cutting vegetation is also disclosed. In this embodiment, the apparatus comprises a cutting head, a handle attached to the cutting head, and a power unit attached to the handle and supplying power to the cutting head. The apparatus further comprises a clamp member having disposed therein the device handle, with the clamp member including a cylinder member and dial means for rotating the handle in order to adjust the handle's angle, a pole support operatively associated with the cylinder member, and means for selectively attaching the clamp member to the pole support. In this embodiment, the apparatus further comprises an angle adjustment plate operatively attached to the pole support, with the angle adjustment plate having a bracket extending therefrom, a wheel member operatively attached to the bracket, and a series of apertures in the angle adjustment plate. A pole support axis intersects the mid-point of the wheel member. The apparatus further includes a tab member operatively attached to the pole support for rotating the pole support into engagement with a selected aperture in order to orient the wheel member to a desired position.

An advantage of the present invention is the control and ease of operation that the operator exercises over the trimmer. Another advantage of the present invention is that the design allows for greater operator control of the cutting head to meet individual needs. Another advantage is that due to the design, the cutting blade does not gouge the ground, which in turn leads to greater control. Yet another advantage is that the ergonomically engineered design allows for minimum strain and stress to the user's body, including the back, arms and legs. In particular, with the present apparatus, stress and strain to the operator's back is significantly reduced. Still yet another advantage is that the operator's wrist controls most of the operation.

Yet another advantage is that the disclosed apparatus will work with all trimmers. Yet another advantage is that the cutting line can still be extended in the same manner that most trimmers employ i.e. tapping on the line hub on the bottom of the cutting head. Still yet another advantage is that the apparatus of the present disclosure does not limit the functionality of the trimmer. In other words, the operator uses the trimmer in the manner that the trimmer was originally designed. Another advantage is the apparatus allows for multiple height positions of the cutting head.

A feature of the present invention is the wheel design. For instance, the wheel has a wide width thereby minimizing friction as the wheel travels along the ground level. The width of the wheel is designed to lessen the pressure of the wheel traveling over various surfaces including but not limited to grass, concrete, gravel, sand, etc. Another feature of the present invention is that in the most preferred embodiment, the wheel has three surfaces including two (2) elliptical surfaces and one (1) cylindrical surface. Yet another feature is that the wheel will not hinder or compromise normal operation of the trimmer.

Another feature is that the orientation of the cutting head relative to the wheel direction is adjusted by the operator selecting the appropriate aperture in the angle adjustment plate. Changing wheel direction is a simple and intuitive step. Yet another feature is that the tab rotates the pole support, which in turn re-directs the handle of the cutting device which sets the cutting head in the correct orientation for the operator.

Still yet another feature is that with the wheel, lateral ground movement of the cutting head is facilitated by the rotating blade creating a forward force by the action of the rotating blade against the vegetation. In other words, the rotating blade acts against the vegetation, which in turn creates a force that tends to pull the wheel and cutting head forward. Hence, with the addition of the wheel, the trimmer becomes somewhat self-propelled. Yet another feature is that the cutting head can be rotated 90 degrees in order for the trimmer to function as an edger, such as seen in FIG. 6. Still yet another feature is the dial member that is used to adjust the angle of the handle.

### BRIEF DESCRIPTION OF THE DRAWINGS

FIG. 1 is a perspective view of the apparatus of the present disclosure.

FIG. 2 is an exploded view of the apparatus seen in FIG. 1.

FIG. 3 is a side view of the apparatus seen in FIG. 1.

FIG. 4 is a partial front view of apparatus seen in FIG. 3 taken along line 4-4.

FIG. 5 is a partial front view of the apparatus seen in FIG. 3 taken along line 5-5.

FIG. 6 is a perspective view of the apparatus seen in FIG. 1, wherein the cutting head has been tilted to a vertical position.

FIG. 7 is a top perspective view of the apparatus seen in FIG. 6.

FIG. 8 is a perspective side view of the apparatus seen in FIG. 1 showing the clamp member in different positions.

FIG. 9 is a perspective side view of the apparatus seen in FIG. 1 illustrating the wheel being rotated in different positions by the dial means.

### DETAILED DESCRIPTION OF THE PREFERRED EMBODIMENTS

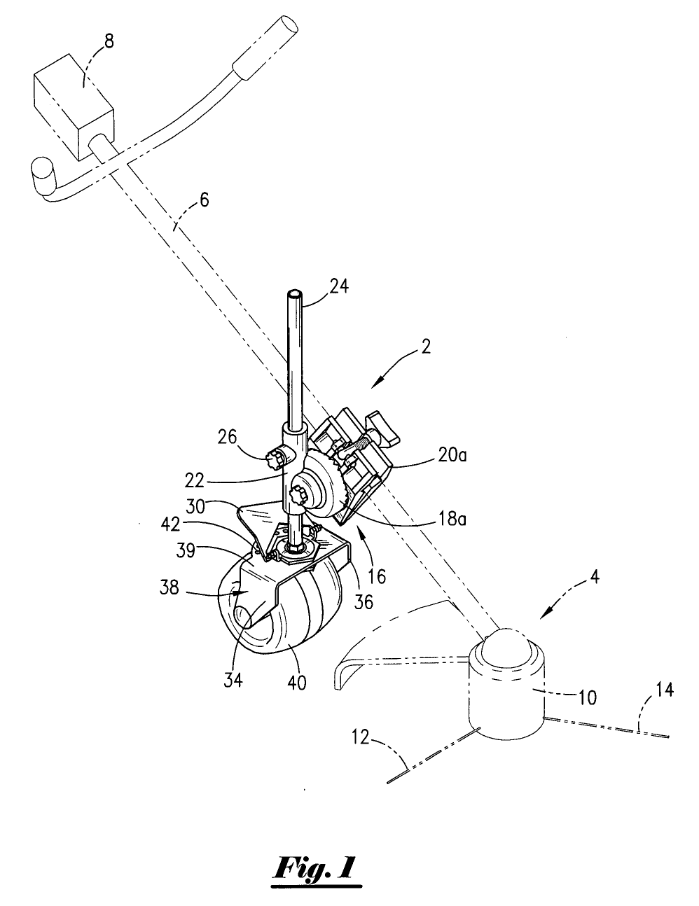

Referring now to FIG. 1, a perspective view of the apparatus 2 of the present disclosure will now be described. The apparatus 2 is clasping a cutting device, wherein the cutting device includes a cutting head 4, a handle 6 connected to the cutting head 4, and a power unit 8 for supplying power to the cutting head 4, and wherein the handle 6 is connected to the power unit 8. The power unit 8 may include a connection to an alternating current circuit, direct current circuit, or a combustible fuel engine means. Cutting devices are commercially available, as noted earlier. The cutting head 4 contains a shield S.

The cutting head 4 has a center hub 10 that has extending therefrom blades 12, 14. The blades are generally constructed of a flexible, polymeric material in the nature of fishing line. The hub 10 is rotated, generally by electrical means or combustible fuel engine means generated via the power unit 8, thereby causing the blades to rotate and cut the vegetation as well understood by those of ordinary skill in the art. Rigid blades may be used in place of the flexible blades. In the most preferred embodiment, a combustible fuel engine means is used as the power unit 8.

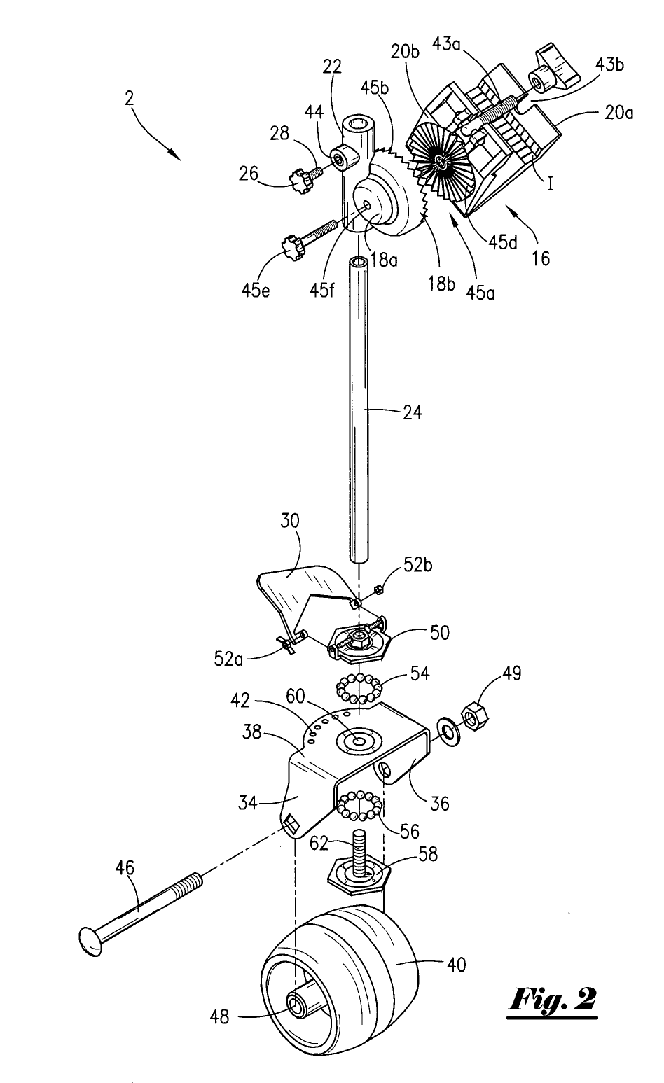

The apparatus 2 includes a clamp member 16, and wherein the clamp member 16 has disposed therein the handle 6. The clamp member 16 has two segments, generally seen at 18a, 20a. The clamp member 16 also includes the cylinder member 22. A pole support 24 is disposed within the cylinder member 22. The clamp member 16 contains means for selectively attaching the clamp member 16 to the pole support 24; more specifically, the attaching means includes knob 26 with a stem 28 (seen in FIG. 2), and wherein the stem 28 is configured to engage the pole support 24 in order to slidably adjust the clamp member 16 relative to the pole support 24.

FIG. 1 also depicts the tab member 30 that is operatively attached to the pole support 24 for rotating the pole support 24 in order to properly orient the cutting head 4. FIG. 1 also depicts the angle adjustment plate, seen generally at 38. The angle adjustment plate 38 includes the two sides 34, 36 as well as the top surface 39. The angle adjustment plate 38 contains the means for orienting the angle adjustment plate 38 to a proper orientation with respect to the wheel 40. The orienting means includes a plurality of apertures, seen generally at 42. As will be explained later in the disclosure, the tab member 30 will cooperate with the apertures 42 in order to adjust the direction of the wheel 40 properly relative to the cutting head 4. The angle adjustment plate 38 also serves to provide as an axle wheel frame. The wheel 40 and bracket sides 34, 36 are sometimes referred to as caster means.

Referring now to FIG. 2, an exploded view of the apparatus 2 seen in FIG. 1 will now be described. It should be noted that like numbers appearing in the various figures refer to like components. The clamp member 16 is shown in the first segment 18a and in the second segment 20a. The indented portion I of the clamp 16 is also shown. A latch means for latching the first handle grasping halves together is shown generally at 43a. The latch means 43a is a shank with thread means and head with cooperating thread means, wherein the head is configured to engage with the groove 43b. The knob 26 and stem 28 are shown, and wherein the stem 28 will cooperate to threadly engage the opening 44 in order to lock the pole support 24 in place relative to cylinder member 22. FIG. 2 also shows dial means 45a for rotating the handle 6 so that the angle of the handle 6 is adjusted. The dial means 45a is a first plate 18b formed on the first segment 18a and a second plate 20b formed on the second segment 20a. The dial means 45a includes a series of serrated teeth 45b extending from a center on the plate 18b; a matching set of serrated teeth 45d is contained on the plate 20b, wherein reciprocal teeth 45d also radiate from a center as seen in FIG. 2. Hence, the operator can rotatably adjust plates 18b, 20b in order to angularly adjust the handle 6 relative to the pole support 24. The threaded stem and knob 45e fit through the opening 45f and engages the plates 18b and 20b in order to attach plates 18b and 20b together at the desired angle.

Additionally, FIG. 2 depicts the angle adjustment plate 38 which includes the bracket side and the bracket side 36 with openings therein, and wherein the axle member 46 cooperates with the opening 48 on the wheel 40, and in this way the wheel 40 is connected to the angle adjustment plate 38 via the nut 49 threadedly engaging with the threads on the axle member 46.

FIG. 2 also depicts the tab member 30 as well as the lock nut 50. The tab member 30 is pivotly connected to the lock nut 50 via the wing nuts 52a, 52b. Also shown is the thrust bearing members 54 above the plate 38 and the thrust bearing members 56 below the plate 38 for facilitating rotation and distributing loads. The double bearing members 54, 56 makes it easy for the operator to make direction changes. The securing bolt 58 will be disposed through the opening 60 on the plate 38. The threads 62 will engage with internal threads (not seen in this view) within the pole support 24. Hence, in order to fasten the pole support 24 to the plate 38, the bolt 58 is threadedly engaged with the pole support 24. It should be noted that the tab member 30 has on its underside (not seen in this view) a pin that will engage with the apertures 42; therefore, in order to set the proper wheel 40 direction and orientation, the tab member 30 is pivoted upward, unlocking the pin; the tab member 30 is rotated to a new position; and, the tab member 30 is pivoted downward so that the pin engages another aperture.

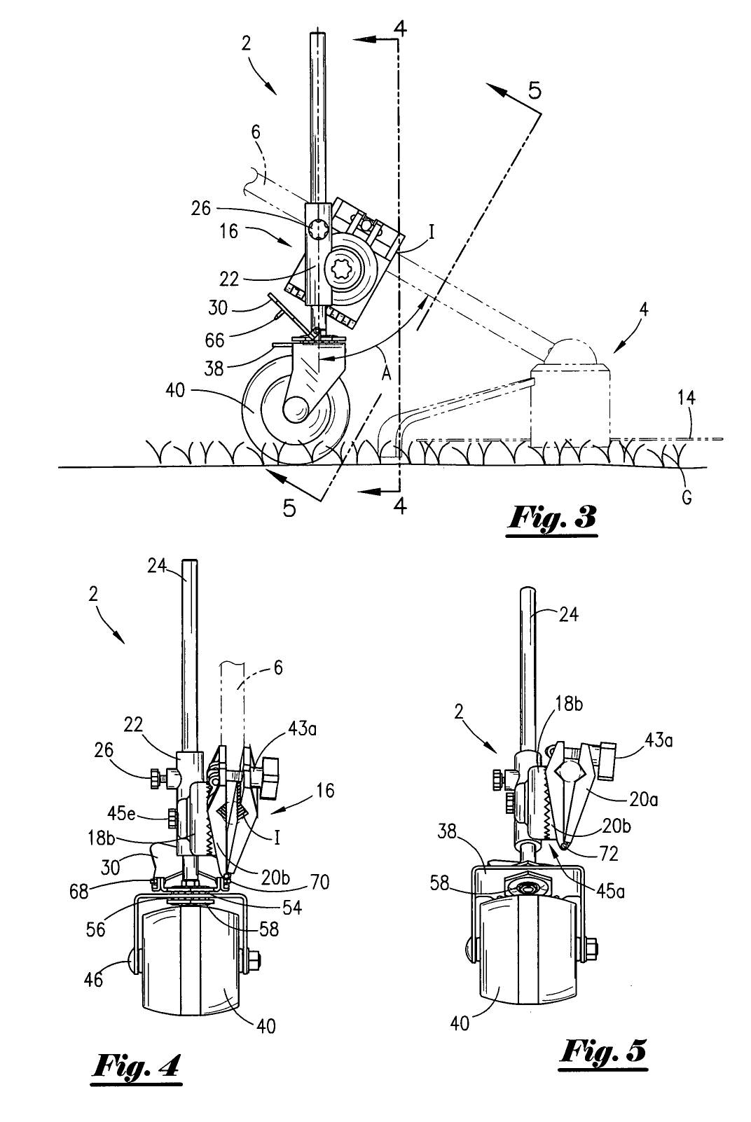

Referring now to FIG. 3, a side view of the apparatus 2 seen in FIG. 1 will now be described. The clamp member 16 is engaging the handle 6 at the desired height, which in turn places the cutting head 4 at the desired height. In the most preferred embodiment, the angle of the cylinder member 22 to the indented portion I is approximately 45 degrees denoted by A. In the view of FIG. 3, the tab member 30 has been pivoted upward. As shown, the pin 66 is not engaged with the angle adjustment plate 38 so that the operator may rotate the wheel 40 in the desired direction, as per the teachings of this invention. Once the desired direction is chosen, the operator simply pivots the tab member 30 downward and engages the pin 66 with the desired aperture to give the proper wheel 40 direction orientation.

As an alternative to raising the height of the cutting head 4, the knob 26 is disengaged, the clamp member 16 is moved upward relative to the pole support 24, the knob 26 reset thereby adjusting the height of the cutting head 4. As noted earlier, the operator can also move the handle 6 within the indented portion I of the clamp member 16 either in or out, which will have an effect of raising or lowering the cutting head 4. Additionally, the operator can rotate handle 6 within the indented portion I of the clamp member 16 which in turn will rotate the inclination of the cutting head 4. As seen in FIG. 3, the cutting head 4, and in particular blade 14, is cutting the grass G in a perpendicular orientation.

Referring now to FIG. 4, a partial front view of apparatus 2 taken along line 4-4 of FIG. 3 will now be described. FIG. 4 shows the pole support 24 fitted through the cylinder member 22. The knob 26 secures the pole support 24. The handle 6 is disposed through the clamp member within the indentation I. The handle grasping halves are shown latched via latch means 43a, and knob and stem 45e is shown connecting the plate 18b and plate 20b together. Also, the securing bolt 58 is shown, along with the axle member 46. FIG. 4 also depicts the double thrust bearings 54, 56. The tab member 30 is shown, as well as the pivot points 68, 70 for pivoting the tab member 30.

FIG. 5 is a partial front view of the apparatus 2 taken along the line 5-5 of FIG. 3. The latch means 43a is shown in the latched position using the handle grasping halves. The handle grasping halves are connected at pivot point 72. FIG. 5 also depicts the securing bolt 58. The serrated teeth of the dial means 45a of the two plates 18b, 20b are also seen in FIG. 5.

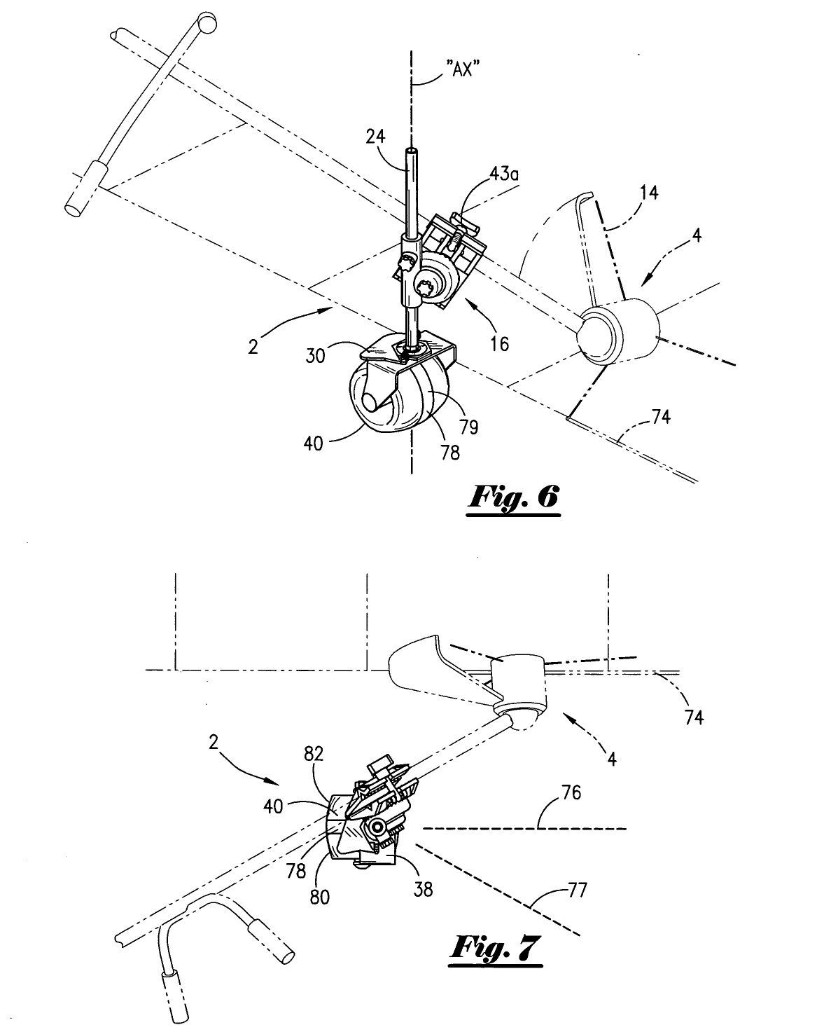

Referring now to FIG. 6, a perspective view of the apparatus 2 seen in FIG. 1 wherein the cutting head 4 has been tilted to a vertical position i.e. the cutting blade 14 is vertical relative to the ground, which as depicted is the sidewalk-grass interface 74. The operator accomplished rotating the cutting head 4 into the position shown in FIG. 6 by unlatching the latch means 43a, rotating the handle 6 to the desired position, latching the latch means 43a, and activating the power unit. Note that it may be desirable that the operator move the clamp member 16 (relative to the pole support) up or down in order adjust the cutting head to the proper height. As per the teachings of the present invention, the operator can also adjust the wheel 40 direction relative to the clamp member 16 so that the operator can assume the proper position for operation of the cutting head 4. As mentioned earlier, the direction of the wheel 40 relative to the clamp member is adjusted via the angle adjustment plate, and in particular, use of the pin on the tab member to engage the proper aperture.

FIG. 7 is a top perspective view of the apparatus 2 seen in FIG. 6. As shown, the cutting head 4 is generally vertical to the sidewalk-grass interface 74. Also, the direction of the wheel 40 is denoted by the line 76. As per the teachings of the present disclosure, the direction of the wheel can be changed by readjusting the pin's engagement with the apertures within the angle adjustment plate 38, as previously described; for instance, the direction can be adjusted to the direction denoted by the line 77.

Additionally, FIG. 7 shows that the wheel 40 has a center cylindrical surface 78, a first elliptical surface 80 on one side, and a second elliptical surface 82 on the opposite side. The operator may change the direction of travel of the wheel 40 by tilting the wheel 40 on elliptical surface 80 (which will be a curved, circular path) and/or tilting onto elliptical surface 82 (which will also be a curved, circular path).

The center cylindrical surface 78 is configured to contact the ground surface. The surface has a width, and wherein the surface 78 acts to reduce the friction between the wheel 40 and the ground surface. Also, as seen in FIG. 6, the pole support 24 has a longitudinal axis “AX” there through, and wherein the axis “AX” intersects the cylindrical surface 78 at the mid-way point 79 as seen in FIG. 6. The position of the axis “AX” relative to the cylinder surface 78 allows for easy and accurate rotation of the cutting head to the desired orientation.

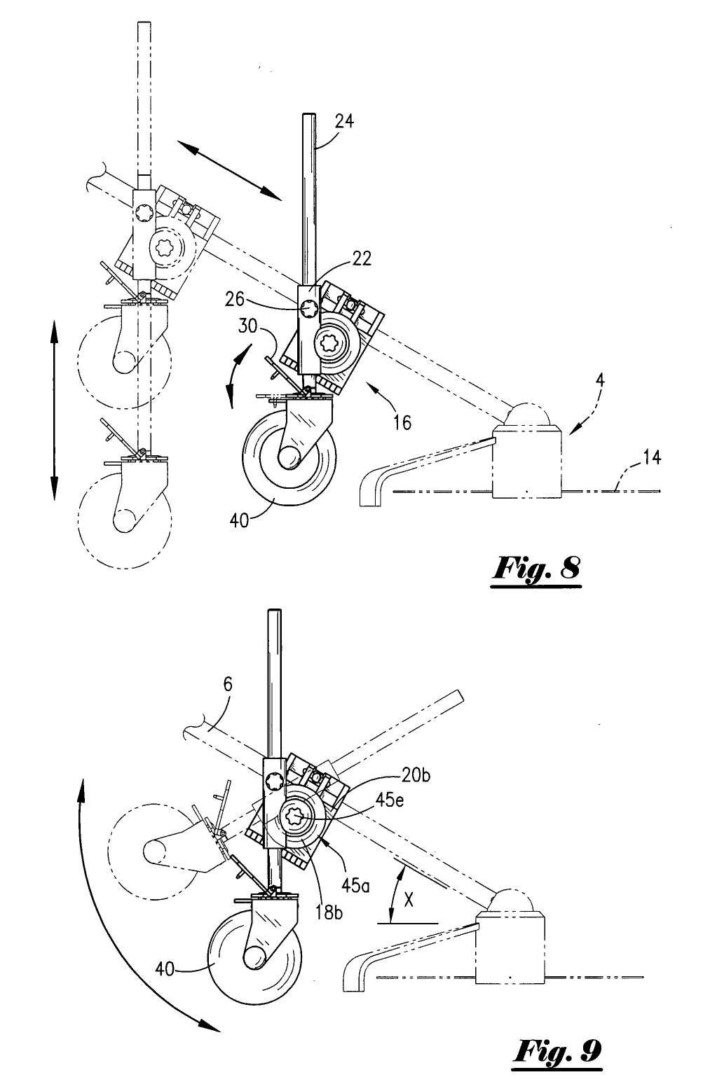

In FIG. 8, a perspective side view of the apparatus seen in FIG. 1 showing the clamp member 16 in different positions. FIG. 8 depicts the clamp member 16 (solid lines) in a first position. The phantom lines show clamp member 16 in a second position wherein the knob 26 has been released, and the clamp member 16 brought up the pole support 24, or alternatively, the clamp member 16 brought down the pole support 24. The position is selected by the specific circumstances of the cutting and the operator preferences.

FIG. 9 illustrates a perspective view of the apparatus seen in FIG. 1 depicting the wheel 40 being rotated in different positions by the dial means 45a. The dial means 45a has been rotated as per the teachings of this description. The phantom lines show where the operator, based on his unique conditions, may wish to adjust the handle 6 relative to the wheel 40. In order to adjust, the operator will back-off the knob 45e, rotates the dial face, engages the teeth in the new, desired position, and tightens the knob 45e i.e. the plates 18b and 20b have been rotated and the teeth then engage at the desired angle of the handle 6. As noted, the angle “X” would change accordingly.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

1. An apparatus for handling a vegetation cutting device, the cutting device including a cutting head, a handle attached to the cutting head, and a power unit attached to the handle and supplying power to the cutting head, the apparatus comprising:
a clamp member having disposed therein the handle of the cutting device, said clamp member including a cylinder member and a clamp assembly, said clamp assembly having two matching V-shaped halves, each of said halves with a proximal end and a distal end, said distal end of each of said halves being pivotally connected, said clamp assembly containing an indented portion for engaging the handle of said cutting device;
a pole support operatively associated with said cylinder member, said pole support having an axis there through, said cylinder member including an elongated integral tubular portion that encases a portion of said pole support;
an attaching assembly associated with said clamp member, said attaching assembly including an adiustable knob and connected stem, said stem being configured to engage said pole support in order to slidably adjust said pole support relative to said clamp member;
angle adjustment plate operatively attached to said pole support, said angle adjustment plate having a bracket extending therefrom;
a wheel member operatively attached to said bracket, said wheel member having a first elongated elliptical surface extending to a cylindrical surface, said cylindrical surface extending to a second elongated elliptical surface, and said cylindrical surface contacts the ground in order to reduce the friction of said wheel member to the ground, and wherein said axis of said pole support intersects a mid-point of said cylindrical surface, and said wheel member
means for orienting said angle adjustment plate to a proper orientation with respect to said wheel member, said means for orienting including a series of apertures in said angle adjustment plate;
a tab member operatively attached to said pole support for rotating said pole support to align with said orienting means;
a locking means for locking said tab member in place relative to said angle adjustment plate, said locking means comprising a pin directly affixed to said tab member, wherein said pin is configured to engage a selected aperture of said series of apertures in said angle adjustment plate such that said wheel is prevented from swiveling with respect to said tab member but not prevented from rolling.

2. (canceled)

3. The apparatus of claim 1 wherein the indented portion of said clamp assembly is at an angle between 30 degrees and 50 degrees relative to the pole support.

4. (canceled)

5. (canceled)

6. (canceled)

7. (canceled)

8. (canceled)

9. (canceled)

10. An apparatus for holding a vegetation cutting device, the device including a cutting head, a handle attached to the cutting head, and a power unit attached to the handle and supplying power to the cutting head, the apparatus comprising:
a clamp member having disposed therein the device handle, said clamp member including a cylinder member, a dial means for rotating the handle so that the angle of the handle is adjustable, and a clamp assembly having to matching V-shaped halves, each of said halves with a proximal end and a distal end, said distal end of each of said halves being pivotally connected, said clamp assembly containing an indented portion for engaging said handle of said cutting device;
a pole support operatively associated with said cylinder member, said cylinder member including an elongated integral tubular portion that encases a portion of said pole support;
an attaching assembly associated with said clamp member, said attaching assembly including an adjustable knob and connected stem, said stem being configured to engage said pole support in order to slidably adjust said pole support relative to said clamp member;
angle adjustment plate operatively attached to said pole support;
a caster means, operatively attached to said pole support, for rotatably moving the cutting head, said caster means including a bracket extending from said angle adjustment plate, said caster means further including a wheel operatively attached to said bracket, said wheel including a first elongated elliptical surface extending to a cylindrical surface, said cylindrical surface extending to a second elongated elliptical surface:
means for orienting said angle adjustment plate to a proper orientation with respect to said caster means, said means for orienting including a series of apertures in said angle adjustment plate;
a tab member operatively attached to said pole support for rotating said pole support to align with said orienting means;
a locking means for locking said tab member in place relative to said angle adjustment plate, said locking means comprising a pin directly affixed to said tab member, wherein said pin is configured to engage a selected aperture of said series of apertures in said angle adjustment plate such that said wheel is prevented from swiveling with respect to said tab member but not prevented from rolling.

11. (canceled)

12. (canceled)

13. (canceled)

14. The apparatus of claim 12 wherein the dial means includes a first plate having serrated teeth disposed about a center of the first plate and a second plate having reciprocal serrated teeth disposed about a center of the second plate.

15. (canceled)

16. (canceled)

17. (canceled)

18. (canceled)

19. (canceled)

20. A method for cutting vegetation comprising the steps of:
providing a cutting device, said device comprising: a cutting head; a handle attached to the cutting head; a power unit attached to the handle and supplying power to the cutting head; a clamp having disposed therein the device handle, said clamp including a cylinder member and a clamp assembly, said clamp assembly having two matching V-shaped halves, each of said halves with a proximal end and a distal end, said distal end of each of said halves being pivotally connected, said clamp assembly containing an indented portion for engaging the handle of said cutting device; a pole operatively associated with said cylinder member, said cylinder member including an elongated integral tubular portion that encases a portion of said pole; an attaching assembly associated with said cylinder member, said attaching assembly including an adjustable knob and connected stem, said stem being configured to engage said pole support in order to slidably adjust said pole support relative to said cylinder member; angle adjustment plate operatively attached to said pole, said angle adjustment plate having a bracket extending therefrom; a wheel operatively attached to said bracket; a series of apertures for orienting said angle adjustment plate to a proper orientation; a tab operatively attached to said pole for, rotating said pole for selecting the aperture; a locking means for locking said tab in place relative to said angle adjustment plate, said locking means comprising a pin directly affixed to said tab, wherein said pin is configured to engage a selected aperture of said series of apertures in said angle adjustment plate such that said wheel is prevented from swiveling with respect to said tab but not prevent from rolling:
adjusting the height of the clamp relative to the pole so that the height of the cutting head is changed;
energizing the power unit;
rotating the cutting head;
cutting vegetation with the cutting head.

21. The method of claim 20 further comprising the steps of:
terminating the power to the power unit;
adjusting the orientation of the wheel, wherein the orientation of the wheel is adjusted by engaging the tab with a selected aperture so that the direction of the wheel is adjusted.

22. A device for cutting vegetation comprising:
a cutting head;
a handle attached to the cutting head;
a power unit attached to the handle and supplying power to the cutting head;
a clamp member having disposed therein the device handle, said clamp member including a cylinder member, a dial means for rotating the handle so that the angle of the handle is adjustable, and a clamp assembly, said clamp assembly having two matching V-shaped halves, each of said halves with a proximal end and a distal end, said distal end of each of said halves being pivotally connected, said clamp assembly containing an indented portion for engaging the handle of said cutting device;
a pole support operatively associated with said cylinder member, said pole support having an axis there through, said cylinder member including an elongated integral tubular portion that encases a substantial portion of said pole support;
an attaching assembly associated with said clamp member, said attaching assembly including an adjustable knob and connected stem, said stem being configured to engage said pole support in order to slidably adjust said pole support relative to said clamp member;
an angle adjustment plate operatively attached to said pole support, said angle adjustment plate having a bracket extending therefrom;
a wheel member operatively attached to said bracket, said wheel member including a first elongated elliptical surface extending to a cylindrical surface, said cylindrical surface extending to a second elongated elliptical surface, and wherein said axis of said pole support intersects a mid-point of said wheel member;
a series of apertures in said angle adjustment plate;
a tab member operatively attached to said pole support for rotating said pole support into engagement with a selected aperture in order to orient the wheel member to a desired position;
a locking means for locking said tab member in place relative to said angle adjustment plate, said locking means comprising a pin directly affixed to said tab member, wherein said pin is configured to engage a selected aperture of said series of apertures in said angle adjustment plate such that said wheel is prevented from swiveling with respect to said tab member but not prevented from rolling.
